(19) United States
(12) Patent Application Publication
(10) Pub. No.: US 2019/0324316 A1
(43) Pub. Date: Oct. 24, 2019

(54) HEATING SYSTEM AND METHOD OF HEATING DISPLAY PANEL

(71) Applicant: Shenzhen China Star Optoelectronics Semiconductor Display Technology Co., Ltd., Shenzhen (CN)

(72) Inventor: Xiangyang XU, Shenzhen (CN)

(21) Appl. No.: 16/079,110

(22) PCT Filed: Jul. 25, 2018
(86) PCT No.: PCT/CN2018/096967

§ 371 Date: Aug. 23, 2018

(30) Foreign Application Priority Data
Apr. 23, 2018 (CN) 201810366301.4

(51) Int. Cl. G02F 1/1333; G02F 1/1345; H05B 3/26

(52) U.S. Cl. CPC G02F 1/133382; H05B 3/26; G02F 1/13452

(57) ABSTRACT

A heating system of a display panel and a method of heating the display panel are disclosed. The heating system comprises a temperature sensor, a control chip, a current source, and at least four terminals. In this disclosure, a good solution is provided for the deterioration of liquid crystal molecular properties of the display panel in a low temperature environment by closing/opening the part of the terminals to connect in series/short-circuit with the wires located at the display area, and it also ensures display brightness of the display panel.

### FIELD OF INVENTION

The present invention relates to a display technology, and more particularly to a heating system of a display panel and a method of heating a display panel.

### BACKGROUND OF INVENTION

Currently, liquid crystal display technology is widely used in televisions, cell phones, and public information displays. One important criteria for the success of these product is picture quality. Among parameters determining picture quality, brightness of the liquid crystal display is an important parameter standard.

An LCD panel includes an array substrate, a color filter substrate, and a liquid crystal material disposed between both of them. The liquid crystal itself does not emit light, and this it is necessary to adjust the brightness of the backlight to achieve picture display. However, low-temperature polysilicon displays uses conventional liquid crystal display technology, whose liquid crystals are affected by low temperature, so that poor picture and optical characteristics often occur in low temperature environments. In low temperature conditions, the liquid crystal display panel will present a display with obvious differences in brightness, contrast, and color gamut, the display under the low temperature is different from that under normal temperature, and display quality is affected so that the user experience is significantly lowered.

In the prior art, in order to improve the corresponding performance of the liquid crystal molecules in low temperatures, a method of heating the liquid crystal panel is adopted. The method of heating usually provides a heating film on the surface of the liquid crystal panel. The heating film can be placed in the backlight film or on the surface of the liquid crystal panel, but this arrangement reduces the brightness of the liquid crystal panel.

### SUMMARY OF INVENTION

The present invention provides a heating system of a display panel and a method of heating a display panel to solve technical problems of brightness reduction in the current display panel under the premise of ensuring the performance of liquid crystal molecules.

For solving above problems, technical solutions of the present invention is as follows:

The present invention provides a heating system of a display panel, comprising a temperature sensor, a control chip, a current source, and at least four terminals; wherein

when the display panel has a temperature lower than a first threshold value, the control chip opens a part of the terminals by outputting a control instruction, so that the heating system connects in series with wires located at a display area of the display panel; and when the display panel has a temperature higher than the first threshold value, the control chip closes the part of the terminals by outputting the control instruction, so that the heating system and the wires located at the display area of the display panel have a short-circuit connection with each other;

wherein the control chip controls a first current value output by the current source according to a temperature signal transmitted by the temperature sensor;

when the display panel has a temperature lower than a second threshold value, the control chip controls the current source to increase the first current value; and when the display panel has a temperature higher than the second threshold value, the control chip controls the current source to decrease the first current value.

According to one preferred embodiment of the present invention, the heating system includes a first terminal, a second terminal, a third terminal, and a fourth terminal;

the first terminal connects in parallel with the second terminal, the third terminal connects in parallel with the fourth terminal, the first terminal and the second terminal connect with a first output end, the third terminal and the fourth terminal connect with a second output end, and the first output end and the second output end are output ends independent from each other.

According to one preferred embodiment of the present invention, when the display panel has a temperature lower than the first threshold value, the control chip opens one of the first terminal and the second terminal by outputting the control instruction, so that the heating system connects in series with the wires located at the display area of the display panel.

According to a preferred embodiment of the present invention, the heating system further comprises a driving chip configured to receive the control instruction of the control chip and open or close the part of the terminals according to the control instruction.

The present invention further provides a method of heating a display panel comprising a heating system having a temperature sensor, a control chip, a current source, and at least four terminals, comprising steps of:

using the temperature sensor to monitor a temperature of a display area of the display panel to generate a temperature signal, and transmit the temperature signal to the control chip; and

generating a control instruction by the control chip according to the temperature signal for opening or closing a part of the terminals; wherein,

when the display panel has a temperature lower than a first threshold value, the control chip opens the part of the terminals by outputting a control instruction, so that the heating system connects in series with wires located at the display area of the display panel; and

when the display panel has a temperature higher than the first threshold value, the control chip closes the part of the terminals by outputting the control instruction, so that the heating system and the wires located at the display area of the display panel have a short-circuit connection with each other.

According to a preferred embodiment of the present invention, the heating system further comprises a driving chip configured to receive the control instruction of the control chip and open or close the part of the terminals according to the control instruction.

According to a preferred embodiment of the present invention, heating system includes a first terminal, a second terminal, a third terminal, and a fourth terminal;

the first terminal connects in parallel with the second terminal, the third terminal connects in parallel with the fourth terminal, the first terminal and the second terminal connect with a first output end, the third terminal and the fourth terminal connect with a second output end, and the first output end and the second output end are outputs independent from each other.

According to a preferred embodiment of the present invention, when the display panel has a temperature lower than the first threshold value, the control chip opens one of the first terminal and the second terminal by outputting the control instruction, so that the heating system connects in series with the wires located at the display area of the display panel.

According to a preferred embodiment of the present invention, the control chip controls a first current value output by the current source according to a temperature signal transmitted by the temperature sensor;

when the display panel has a temperature lower than a second threshold value, the control chip controls the current source to increase the first current value; and when the display panel has a temperature higher than the second threshold value, the control chip controls the current source to decrease the first current value.

The present invention further provides a heating system of a display panel comprising a temperature sensor, a control chip, a current source, and at least four terminals; wherein

when the display panel has a temperature lower than a first threshold value, the control chip opens a part of the terminals by outputting a control instruction, so that the heating system connects in series with wires located at a display area of the display panel; and when the display panel has a temperature higher than the first threshold value, the control chip closes the part of the terminals by outputting the control instruction, so that the heating system and the wires located at the display area of the display panel have a short-circuit connection with each other.

According to a preferred embodiment of the present invention, the heating system comprises a first terminal, a second terminal, a third terminal, and a fourth terminal;

the first terminal connects in parallel with the second terminal, the third terminal connects in parallel with the fourth terminal, the first terminal and the second terminal connect with a first output end, the third terminal and the fourth terminal connect with a second output end, and the first output end and the second output end are outputs independent from each other.

According to a preferred embodiment of the present invention, when the display panel has a temperature lower than the first threshold value, the control chip opens one of the first terminal and the second terminal by outputting the control instruction, so that the heating system connects in series with the wires located at the display area of the display panel.

According to a preferred embodiment of the present invention, the heating system further comprises a driving chip configured to receive the control instruction of the control chip and open or close the part of the terminals according to the control instruction.

The beneficial effect of the present invention is to ensure the display brightness of the display panel by closing/opening the part of the terminals so that the heating system connects in series/has a short-circuit connection with the wires located at the display area under the premise of a good solution to the deterioration of the liquid crystal molecular properties of the display panel in a low temperature environment.

### BRIEF DESCRIPTION OF DRAWINGS

In order to more clearly illustrate the technical solutions in the embodiment or in the present invention, the following drawings, which are intended to be used in the description of the embodiment or of the present invention, will be briefly described. It is understood that the drawings described below are merely some embodiments of the present invention, and it will be possible to those skilled in the art to obtain other drawings according to these drawings without creative efforts.

FIG. 1 is a schematic block diagram showing a heating system of a display panel of the present invention.

FIG. 2 is a process scheme showing a method of heating a display panel of the present invention.

### DETAILED DESCRIPTION OF PREFERRED EMBODIMENTS

The description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto. In the drawings, like reference numerals designate like elements throughout the specification.

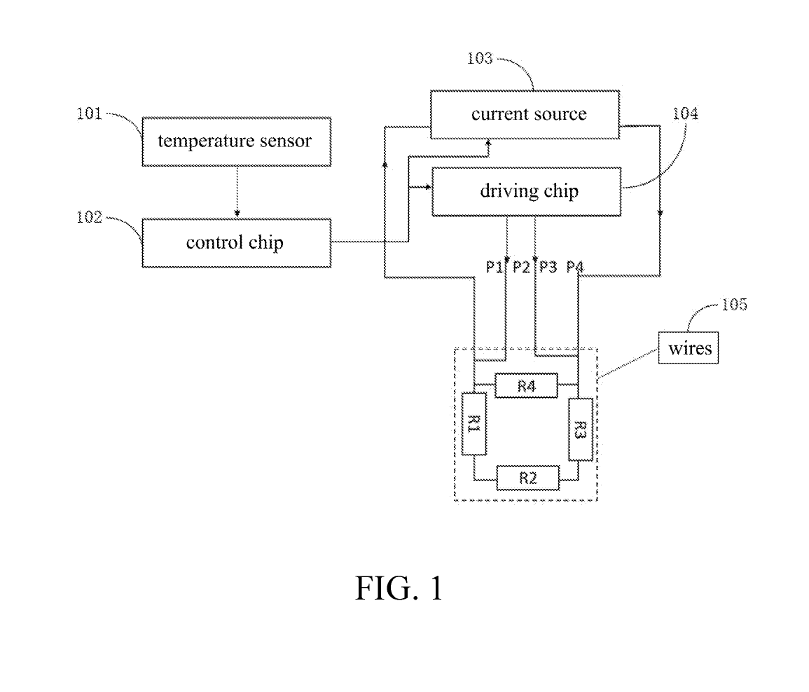

FIG. 1 is a schematic block diagram showing a heating system of a display panel of the present invention, wherein the heating system comprises a temperature sensor 101, a control chip 102, a current source 103, and at least four terminals.

In this embodiment, preferably, the heating system includes a first terminal P1, a second terminal P2, a third terminal P3, and a fourth terminal P4; wherein

the first terminal P1 connects in parallel with the second terminal P2, the third terminal P3 connects in parallel with the fourth terminal P4, the first terminal P1 and the second terminal P2 connect with a first output end, the third terminal P3 and the fourth terminal P4 connect with a second output end, and the first output end and the second output end are output ends independent from each other.

Preferably, the heating system further comprises a driving chip 104 configured to receive the control instruction of the control chip 102 and open or close the part of the terminals according to the control instruction.

Preferably, the driving chip 104 connects with the second terminal P2 and the third terminal P3, and controls the open or close of the second terminal P2 and the third terminal P3. The driving chip can further connect with the first terminal P1 and the fourth terminal P4, and control the open or close of the second terminal P2 and the third terminal P3.

The temperature sensor 101 is mainly configured to monitor a temperature of the display panel, i.e. a temperature of an area of liquid crystal molecules. The temperature sensor 101 is configured to generate a temperature signal according to the obtained temperature, and transmit the temperature signal to the control chip 102.

The control chip 102 is configured to output a control instruction. In this embodiment, the control chip 102 outputs different control instructions to the driving chip 104 and the current source 103.

That is, when a temperature of the display panel lower or higher than a certain threshold, the temperature sensor 101 transmits the generated temperature signal to the control chip 102, and the control chip 102 outputs a control instruction by the received temperature signal. The control instruction is used for controlling the driving chip 104 or the current source 103 to execute different operations.

It can be understood that, when the display panel is subject to a lower temperature, for example a first threshold value A; the temperature sensor 101 transmits the generated temperature signal to the control chip 102. The control chip 102 outputs a control instruction by the received temperature signal. The control instruction is used for controlling the driving chip 104 to open the second terminal P2 and the third terminal P3.

As shown in FIG. 1, when the second terminal P2 and the third terminal P3 close, the wires 105 within the display area of the display panel are connected in short-circuit by the heating system; when the second terminal P2 and the third terminal P3 open, the wires 105 within the display area of the display panel are connected in series by the heating system. Therefore, when the display panel has a temperature lower than the first threshold value A, the driving chip 104 opens the second terminal P2 and the third terminal P3, and the wires 105 within the display area of the display panel are connected in series by the heating system, i.e. the equivalent resistance (wires 105) of the heating system is increased thereby increasing the temperature of the display area of the display panel.

When the temperature of the display panel is higher than the first threshold value A, the temperature sensor 101 transmits the generated temperature signal to the control chip 102. The control chip 102 outputs a control instruction by the received temperature signal. The control instruction is used for controlling the driving chip 104 to close the second terminal P2 and the third terminal P3. The wires 105 within the display area of the display panel are connected in short-circuit by the heating system. That is, the equivalent resistance (wires 105) of the heating system are reduced thereby the temperature of the display area of the display panel no longer increases.

Alternatively, the control chip 102 controls a first current value output by the current source 103 according to the temperature signal transmitted by the temperature sensor 101.

That is, when the temperature of the display panel is lower than a second threshold value B, wherein the first threshold value A is greater than a second threshold value B, the temperature sensor 101 transmits the generated temperature signal to the control chip 102. The control chip 102 outputs a control instruction by the received temperature signal. The control instruction is used for controlling the current source 103 to increase the first current value. That is, the heating amount of the heating system increases.

When the temperature of the display panel is lower than a second threshold value B, and lower than the first threshold value A, the temperature sensor 101 transmits the generated temperature signal to the control chip 102. The control chip 102 outputs a control instruction by the received temperature signal. The control instruction is used for controlling the current source 103 to reduce the first current value. That is, the heating amount of the heating system reduces.

The present invention ensures the display brightness of the display panel by closing/opening the part of the terminals so that the heating system connects in series/has a short-circuit connection with the wires located at the display area under the premise of a good solution to the deterioration of the liquid crystal molecular properties of the display panel in a low temperature environment.

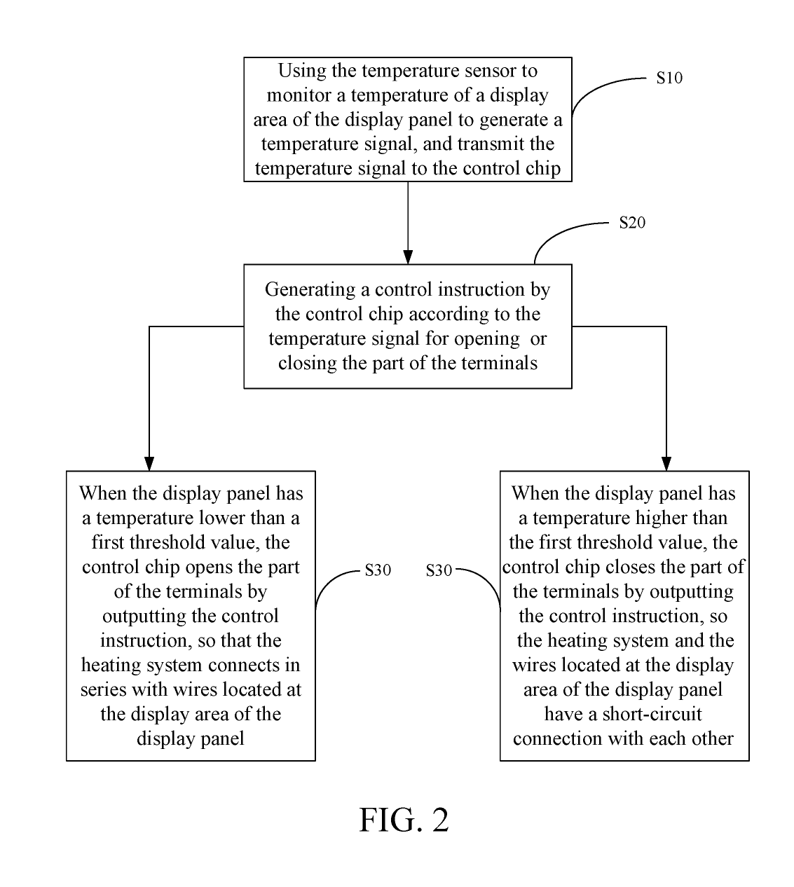

FIG. 2 is a process scheme showing a method of heating a display panel of the present invention, wherein the display panel comprises a heating system having a temperature sensor 101, a control chip 102, a current source 103, and at least four terminals. The method comprises:

Step S10: using the temperature sensor to monitor a temperature of a display area of the display panel to generate a temperature signal, and transmit the temperature signal to the control chip.

The temperature sensor 101 is mainly configured to monitor the temperature of the display panel, i.e. a temperature of an area of liquid crystal molecules; the temperature sensor 101 is configured to generate a temperature signal according to the obtained temperature, and transmit the temperature signal to the control chip 102.

Step S20: generating a control instruction by the control chip according to the temperature signal for opening or closing a part of the terminals.

In this step, preferably, the heating system includes a first terminal P1, a second terminal P2, a third terminal P3, and a fourth terminal P4.

The first terminal P1 connects in parallel with the second terminal P2, the third terminal P3 connects in parallel with the fourth terminal P4, the first terminal P1 and the second terminal P2 connect with a first output end, the third terminal P3 and the fourth terminal P4 connect with a second output end, and the first output end and the second output end are output ends independent from each other.

The heating system further comprises a driving chip 104 configured to receive the control instruction of the control chip 102 and open or close the part of the terminals according to the control instruction.

Preferably, the driving chip 104 connects with the second terminal P2 and the third terminal P3, and controls the open or close of the second terminal P2 and the third terminal P3; the driving chip can further connect with the first terminal P1 and the fourth terminal P4, and control the open or close of the second terminal P2 and the third terminal P3.

Step S30: when the display panel has a temperature lower than a first threshold value, the control chip opens a part of the terminals by outputting a control instruction, so that the heating system connects in series with wires located at a display area of the display panel; and

when the display panel has a temperature higher than the first threshold value, the control chip 102 closes the part of the terminals by outputting the control instruction, so that the heating system and the wires 105 located at the display area of the display panel have a short-circuit connection with each other.

In this step, when the display panel is subject to a lower temperature, for example a first threshold value A, that is, when the temperature of the display panel is lower than the first threshold value, the temperature sensor 101 transmits the generated temperature signal to the control chip 102. The control chip 102 outputs a control instruction by the received temperature signal. The control instruction is used for controlling the driving chip 104 to open the second terminal P2 and the third terminal P3.

As shown in FIG. 1, when the second terminal P2 and the third terminal P3 close, the wires 105 within the display area of the display panel are connected in short-circuit by the heating system; when the second terminal P2 and the third terminal P3 open, the wires 105 within the display area of the display panel are connected in series by the heating system. Therefore, when the display panel has a temperature lower than the first threshold value A, the driving chip 104 opens the second terminal P2 and the third terminal P3, and the wires 105 within the display area of the display panel are connected in series by the heating system, i.e. the equivalent resistance (wires 105) of the heating system is increased thereby increasing the temperature of the display area of the display panel.

When the temperature of the display panel is higher than the first threshold value A, the temperature sensor 101 transmits the generated temperature signal to the control chip 102. The control chip 102 outputs a control instruction by the received temperature signal. The control instruction is used for controlling the driving chip 104 to close the second terminal P2 and the third terminal P3. The wires 105 within the display area of the display panel are connected in short-circuit by the heating system. That is, the equivalent resistance (wires 105) of the heating system are reduced thereby the temperature of the display area of the display panel are no longer increased.

Alternatively, the control chip 102 controls a first current value output by the current source 103 according to the temperature signal transmitted by the temperature sensor 101.

That is, when the temperature of the display panel is lower than a second threshold value B, wherein the first threshold value A is greater than a second threshold value B, the temperature sensor 101 transmits the generated temperature signal to the control chip 102. The control chip 102 outputs a control instruction by the received temperature signal. The control instruction is used for controlling the current source 103 to increase the first current value. That is, the heating amount of the heating system is increased.

When the temperature of the display panel is lower than a second threshold value B, and lower than the first threshold value, the temperature sensor 101 transmits the generated temperature signal to the control chip 102. The control chip 102 outputs a control instruction by the received temperature signal. The control instruction is used for controlling the current source 103 to reduce the first current value. That is, the heating amount of the heating system is reduced.

The present invention provides a heating system of a display panel and a method of heating the display panel. The heating system comprises a temperature sensor, a control chip, a current source, and at least four terminals; when the display panel has a temperature lower than a first threshold value, the control chip opens a part of the terminals by outputting a control instruction, so that the heating system connects in series with wires located at a display area of the display panel. When the display panel has a temperature higher than the first threshold value, the control chip closes the part of the terminals by outputting the control instruction, so that the heating system and the wires located at the display area of the display panel have a short-circuit connection with each other. The present invention is a good solution to the deterioration of the liquid crystal molecular properties of the display panel in a low temperature environment by closing/opening the part of the terminals so that the heating system connects in series/has a short-circuit connection with the wires located at the display area, and it also ensures the display brightness of the display panel.

In summary, the present invention has been described with preferred embodiments thereof and it is understood that many changes and modifications to the described embodiments can be carried out by the skilled person in the art without departing from the scope and the spirit of the invention that is intended to be limited only by the appended claims.

What is claimed is:

1. A heating system of a display panel, comprising:
a temperature sensor, a control chip, a current source, and at least four terminals;
wherein,
when the display panel has a temperature lower than a first threshold value, the control chip opens a part of the terminals by outputting a control instruction, so that the heating system connects in series with wires located at a display area of the display panel; and
when the display panel has a temperature higher than the first threshold value, the control chip closes the part of the terminals by outputting the control instruction, so that the heating system and the wires located at the display area of the display panel have a short-circuit connection with each other;
wherein the control chip controls a first current value output by the current source according to a temperature signal transmitted by the temperature sensor;
when the display panel has a temperature lower than a second threshold value, the control chip controls the current source to increase the first current value; and
when the display panel has a temperature higher than the second threshold value, the control chip controls the current source to decrease the first current value.

2. The heating system according to claim 1, wherein the heating system includes a first terminal, a second terminal, a third terminal, and a fourth terminal;
the first terminal connects in parallel with the second terminal, the third terminal connects in parallel with the fourth terminal, the first terminal and the second terminal connect with a first output end, the third terminal and the fourth terminal connect with a second output end, and the first output end and the second output end are output ends independent from each other.

3. The heating system according to claim 2, wherein,
when the display panel has a temperature lower than the first threshold value, the control chip opens one of the first terminal and the second terminal by outputting the control instruction, so that the heating system connects in series with the wires located at the display area of the display panel.

4. The heating system according to claim 1, wherein the heating system further comprises a driving chip configured to receive the control instruction of the control chip and open or close the part of the terminals according to the control instruction.

5. A method of heating a display panel comprising a heating system having a temperature sensor, a control chip, a current source, and at least four terminals, comprising steps of:
using the temperature sensor to monitor a temperature of a display area of the display panel to generate a temperature signal, and transmit the temperature signal to the control chip; and
generating a control instruction by the control chip according to the temperature signal for opening or closing a part of the terminals; wherein,
when the display panel has a temperature lower than a first threshold value, the control chip opens the part of the terminals by outputting a control instruction, so that the heating system connects in series with wires located at the display area of the display panel; and
when the display panel has a temperature higher than the first threshold value, the control chip closes the part of the terminals by outputting, the control instruction, so that the heating system and the wires located at the display area of the display panel have a short-circuit connection with each other.

6. The method according to claim 5, wherein the heating system further comprises a driving chip configured to receive the control instruction of the control chip and open or close the part of the terminals according to the control instruction.

7. The method according to claim 5, wherein
the heating system includes a first terminal, a second terminal, a third terminal, and a fourth terminal;
the first terminal connects in parallel with the second terminal, the third terminal connects in parallel with the fourth terminal, the first terminal and the second terminal connect with a first output end, the third terminal and the fourth terminal connect with a second output end, and the first output end and the second output end are outputs independent from each other.

8. The method according to claim 7,
wherein, when the display panel has a temperature lower than the first threshold value, the control chip opens one of the first terminal and the second terminal by outputting the control instruction, so that the heating system connects in series with the wires located at the display area of the display panel.

9. The method according to claim 5, wherein
the control chip controls a first current value output by the current source according to a temperature signal transmitted by the temperature sensor;
when the display panel has a temperature lower than a second threshold value, the control chip controls the current source to increase the first current value; and
when the display panel has a temperature higher than the second threshold value, the control chip controls the current source to decrease the first current value.

10. A heating system of a display panel comprising a temperature sensor, a control chip, a current source, and at least four terminals; wherein when the display panel has a temperature lower than a first threshold value, the control chip opens a part of the terminals by outputting a control instruction, so that the heating system connects in series with wires located at a display area of the display panel; and
when the display panel has a temperature higher than the first threshold value, the control chip closes the part of the terminals by outputting the control instruction, so that the heating system and the wires located at the display area of the display panel have a short-circuit connection with each other.

11. The heating system according to claim 10, wherein the heating system comprises a first terminal, a second terminal, a third terminal, and a fourth terminal;
the first terminal connects in parallel with the second terminal, the third terminal connects in parallel with the fourth terminal, the first terminal and the second terminal connect with a first output end, the third terminal and the fourth terminal connect with a second output end, and the first output end and the second output end are outputs independent from each other.

12. The heating system according to claim 11, wherein,
when the display panel has a temperature lower than the first threshold value, the control chip opens one of the first terminal and the second terminal by outputting the control instruction, so that the heating system connects in series with the wires located at the display area of the display panel.

13. The heating system according to claim 10, wherein the heating system further comprises a driving chip configured to receive the control instruction of the control chip and open or close the part of the terminals according to the control instruction.
